(19) United States
(12) Patent Application Publication
(10) Pub. No.: US 2023/0162231 A1
(43) Pub. Date: May 25, 2023

(54) INFORMATION PROCESSING DEVICE AND METHOD

(71) Applicant: TOSHIBA TEC KABUSHIKI KAISHA, Tokyo (JP)

(72) Inventor: Shigeki Nimiya, Yokohama Kanagawa (JP)

(21) Appl. No.: 17/848,463

(22) Filed: Jun. 24, 2022

(30) Foreign Application Priority Data
Nov. 19, 2021 (JP) 2021-188717

(51) Int. Cl. G06Q 30/02

(52) U.S. Cl. CPC G06Q 30/0255; G06Q 30/0222

(57) ABSTRACT

An information processing device and a method that can improve an appealing effect of an advertisement product to consumers. The information processing device includes a status information acquisition unit to acquire status information indicating an operation status of a user terminal of a consumer regarding advertisement information delivered to the user terminal, an order information acquisition unit to acquire order information indicating whether the consumer having the user terminal that is a delivery destination of the advertisement information ordered an advertisement product notified of by the advertisement information, and an output unit to output non-purchase pattern information in which a consumer who is determined as not ordering the advertisement product based on the order information acquired by the order information acquisition unit is associated with the status information on the consumer acquired by the status information acquisition unit.

### CROSS-REFERENCE TO RELATED APPLICATION

This application is based upon and claims the benefit of priority from Japanese Patent Application No. 2021-188717, filed on Nov. 19, 2021, the entire contents of which are incorporated herein by reference.

### FIELD

Embodiments described herein relate to an information processing device and a method.

### BACKGROUND

In related arts, advertisement information on products and service (hereinafter collectively referred to as “products”) to be sold is delivered to user terminals of consumers as a part of sales promotion activities of companies. A system for delivering such advertisement information is proposed.

In a company that sells products, the contents of the advertisement, mainly the display contents displayed on the user terminals, are also studied in order to improve the sales of the products notified of by the advertisement information (hereinafter, also referred to as “advertisement products”).

However, a large number of consumers that are delivery destinations of the advertisement information have different characteristics. Thus, even though the advertisement information is uniformly delivered to the consumers, an appealing effect of the advertisement products to the consumers may not be always high.

### DESCRIPTION OF THE DRAWINGS

FIG. 1 is a diagram showing an outline of an advertisement information delivery system including an information processing device according to one embodiment;

FIG. 2 is a block diagram showing a hardware configuration of the information processing device;

FIG. 3 is a diagram showing a data structure of a member master stored in a memory unit;

FIG. 4 is a diagram showing a data structure of a product master;

FIG. 5 is a diagram showing a data structure of a status master;

FIG. 6 is a diagram showing a data structure of a sales promotion plan master;

FIG. 7 is a diagram showing a data structure of a status management file;

FIG. 8 is a diagram showing a data structure of an order management file;

FIG. 9 is a diagram showing a data structure of a purchase information management file;

FIG. 10 is a diagram showing a data structure of a non-purchase pattern information file;

FIG. 11 is a diagram showing a data structure of a promotion plan setting file;

FIG. 12 is a block diagram showing a functional configuration of a control unit;

FIG. 13 is a flowchart showing a flow of a non-purchase pattern information output process by the control unit;

FIG. 14 is a diagram showing an output result;

FIG. 15 is a flowchart showing a flow of a sales promotion plan setting process by the control unit;

FIG. 16 is a diagram showing contents of a generated delivery group for measurement;

FIG. 17 is a diagram showing an analysis result executed in the sales promotion plan setting process;

FIG. 18 is a diagram showing a data structure of a product characteristic information file stored in a memory unit of an information processing device according to a modification;

FIG. 19 is a diagram showing a data structure of a consumer characteristic information file; and

FIG. 20 is a flowchart showing a flow of a delivery target narrowing process by a control unit.

### DETAILED DESCRIPTION

In general, according to one embodiment, there are provided an information processing device and a method that can improve an appealing effect of an advertisement product to consumers.

The information processing device of the embodiment includes a status information acquisition unit configured to acquire status information indicating an operation status of a user terminal of a consumer regarding advertisement information delivered to the user terminal, an order information acquisition unit configured to acquire order information indicating whether the consumer having the user terminal that is a delivery destination of the advertisement information ordered an advertisement product notified of by the advertisement information, and an output unit configured to output non-purchase pattern information in which a consumer who is determined as not ordering the advertisement product based on the order information acquired by the order information acquisition unit is associated with the status information on the consumer acquired by the status information acquisition unit.

Hereinafter, the information processing device and the method of the embodiment will be described with reference to the drawings. The embodiment is not limited to the embodiment described below. For example, in the embodiment described below, the information processing device is described as an example of a headquarters server managed by a headquarters of a company operating a plurality of stores. Alternatively, the information processing device may be a store server that manages store information, a server that is connected to servers of a plurality of companies and manages information of these companies, and the like.

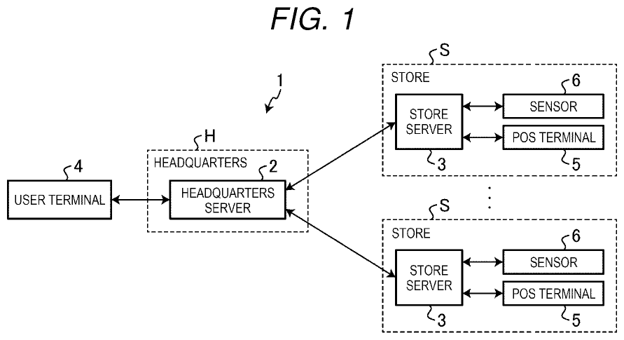

FIG. 1 is a diagram showing an outline of an advertisement information delivery system 1. The advertisement information delivery system 1 of the embodiment described herein is applied to a company that operates a plurality of stores. The advertisement information delivery system 1 includes a headquarters server 2 in a headquarters H, store servers 3 provided in stores S, and user terminals 4 owned by members (hereinafter, also referred to as “consumers”) of the company operating the stores S.

The headquarters server 2 is communicably connected to the store servers 3 of the stores S via a network such as the Internet or a dedicated line. Alternatively, the headquarters server 2 is communicably connected to the user terminals 4 via a network such as the Internet.

The headquarters server 2 functions as an advertisement delivery server that delivers advertisement information to the user terminals 4, an order management server that manages a product order from the user terminals 4, and a consumer management server that manages consumer purchase information and the like. The headquarters server 2 may have a function such as an inventory management server that manages the inventory of each store S.

An outline of a main process executed by the headquarters server 2 of the embodiment described herein is as follows. As a first act, the headquarters server 2 classifies consumers who did not order an advertisement product even though advertisement information was delivered (hereinafter, also referred to as “non-purchasers”) according to operation status of the user terminals 4 regarding the advertisement information. The advertisement information indicates the content of the advertisement product.

Specifically, first, the headquarters server 2 delivers the same advertisement information to the user terminals 4 of the consumers registered as members (hereinafter, also referred to as “delivery for data collection”), and acquires status information on the user terminals 4 and order information on the consumers regarding the advertisement product. The delivery for data collection is desirably delivered to a large number of consumers, for example, by delivering the advertisement information to the user terminals 4 of all the consumers registered as members. Thereafter, the headquarters server 2 identifies the non-purchasers based on the order status received from the user terminals 4, and classifies the non-purchasers according to the operation status based on the status information.

Here, the status information indicates the operation status of the user terminals 4 regarding the notified advertisement information, and is, in this embodiment, information indicating “no confirmation of notification”, “no login to order system”, “logged in to order system but no order input”, “order input”, and the like. The status information can be determined by an operation status within a predetermined period (for example, within two days) after the advertisement information is delivered.

The “no confirmation of notification” is an operation status in which the consumer did not read the received advertisement information. The “no login to order system” is an operation status in which the consumer read the advertisement information but did not operate a guidance to log in to the order system included in the advertisement information. The “logged in to order system but no order input” is an operation status in which the consumer read the advertisement information and logged in to the order system but did not input an order. The “order input” is an operation status in which the consumer read the advertisement information and input an order. These operation statuses are merely examples and can be set freely.

The order information indicates whether the consumer ordered the advertisement product notified of by the advertisement information. Whether the advertisement product was ordered can be determined by whether the headquarters server 2 received the order from the user terminals 4 within a predetermined period (for example, within two days) after the advertisement information was delivered. The headquarters server 2 may acquire the order information from the user terminals 4, or may acquire, from each store S, the order information based on an order separately transmitted from the user terminals 4 to each store S.

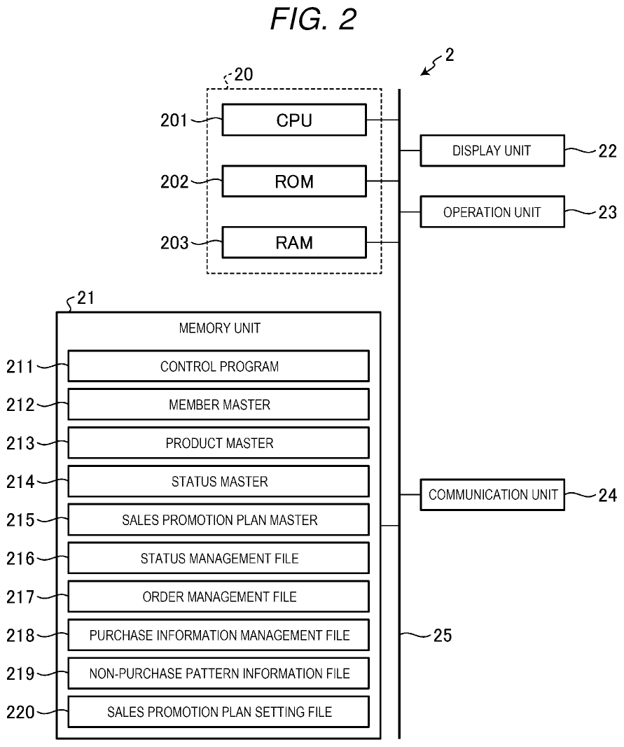

By the first act, the headquarters server 2 recognizes non-purchase patterns of the non-purchasers regarding the delivery for data collection, and outputs non-purchase pattern information indicating the non-purchase patterns. The form of outputting the non-purchase pattern information is freely selected, and may be raw data in which the non-purchasers and the status information are associated with each other, or may be graphed. The output destination of the non-purchase pattern information can also be freely set, and may be a display unit 22 (see FIG. 2) of the headquarters server 2, or may be an external device such as a client personal computer (PC) or a printer (neither shown).

Based on the output non-purchase pattern information, the company that sells products can consider a method for delivering advertisement information, in other words, a sales promotion plan, regarding the subsequent delivery of the advertisement information according to the non-purchase patterns of the consumers. In the non-purchase pattern information, the consumers who are determined as not ordering the advertisement product are associated with the status information on the consumers.

As a second act, the headquarters server 2 delivers advertisement information to measure for which consumers having the non-purchase patterns a plurality of sales promotion plans prepared in advance are effective (hereinafter, also referred to as “delivery for measurement”). Specifically, the plurality of sales promotion plans prepared in advance are applied to each of the non-purchase patterns to deliver the advertisement information.

As one example, three sales promotion plans including X, Y, and Z are prepared in advance, and three non-purchase patterns including AA, BB, and CC are provided in the delivery for data collection. Consumers having the non-purchase pattern AA are divided into three groups to deliver the advertisement information, in which one group of consumers are applied with the sales promotion plan X, another group of consumers are applied with the sales promotion plan Y, and the remaining group are applied with the sales promotion plan Z. Similarly, consumers having the non-purchase pattern BB are divided into three groups to deliver the advertisement information, in which one group of consumers are applied with the sales promotion plan X, another group of consumers are applied with the sales promotion plan Y, and the remaining group are applied with the sales promotion plan Z. Consumers having the non-purchase pattern CC are also processed by the same manner to deliver the advertisement information. As a result, the headquarters server 2 divides the non-purchasers who did not order the advertisement product regarding the delivery for data collection into nine groups and executes the delivery for measurement.

The headquarters server 2 then acquires the status information and the order information regarding the delivery for measurement. By analyzing the status information and the order information, it is possible to measure which sales promotion plan is effective for consumers having each of the non-purchase patterns. As a result, an effective sales promotion plan can be determined for consumers having each of the non-purchase patterns. The analysis related to the status information and the order information regarding the delivery for measurement and the determination of the sales promotion plan based on the analysis may be performed by a person, or may be performed by the headquarters server 2 or the like by utilizing a machine learning model or the like.

As a third act, the headquarters server 2 sets the sales promotion plan determined in the second act and delivers subsequent advertisement information. Specifically, a sales promotion plan determined for each non-purchase pattern, in other words, a sales promotion plan determined for each piece of non-purchaser status information is set as setting information for the subsequent deliveries. The headquarters server 2 executes the subsequent deliveries of the advertisement information to the user terminals 4 according to the set sales promotion plan.

The headquarters server 2 may periodically execute the process from the first act to the third act. The headquarters server 2 may acquire the non-purchase pattern information and the order information for the delivery of the advertisement information and output the non-purchase pattern information each time the advertisement information is delivered. Thereafter, the headquarters server 2 may review each time, based on the output non-purchase pattern information, the sales promotion plan set for each of the non-purchase patterns.

Here, the headquarters server 2 is one example of the information processing device. The headquarters server 2 may include a plurality of computers, or may be implemented by cloud computing.

When a company does not accept orders from the user terminals 4 and only sells products in stores, the headquarters server 2 can perform the process from the first act to the third act in a similar manner as described above by acquiring the consumer purchase information from the store servers 3 of the stores S. Specifically, the headquarters server 2 acquires, from the store servers 3, the purchase information including consumer identification information (member ID, etc.) that identifies the consumers and product identification information (product code, etc.) on the purchased products purchased by the consumers.

The headquarters server 2 can determine whether the consumers purchased the advertisement product based on the purchase information. In other words, the purchase information can be referred to as information indicating whether the consumers purchased the advertisement product. The headquarters server 2 can perform the process from the first act to the third act in a similar manner as described above by adopting the purchase information instead of the order information. In this case, the period for determining whether the advertisement product is purchased can be set to, for example, two weeks from the delivery of the advertisement information. In the case of store sales, the consumers need to go to the stores S in order to purchase the advertisement product, and it takes more time from receiving the advertisement information to purchasing the advertisement product as compared with the case of ordering with the user terminals 4.

The store server 3 is provided in each store S. The store server 3 is communicably connected to a point-of-sales (POS) terminal 5 and a sensor 6 installed in the store S via a network such as a local area network (LAN). The POS terminal 5 executes a payment process of the product purchased by the consumer at the store S. The sensor 6 includes, for example, a scanner, or a radio frequency identification (RFID) reader, and reads a code symbol such as a barcode or a two-dimensional code attached to a received product, or a product code, product information or an individual product code of the product from a wireless tag.

The store server 3 acquires the purchase information including the member ID, the product code of or product information on the purchased product, a trade amount, and the like from the POS terminal 5, and manages sales information on the store S. The store server 3 manages inventory information on the products in the store S based on the product information on the received products acquired from the sensor 6 and the sales information. The store server 3 transmits the purchase information and the inventory information to the headquarters server 2. Accordingly, the headquarters server 2 can manage consumer information including the purchase information and the inventory information of each store S.

The user terminal 4 is an information terminal such as a smartphone or a PC owned by the consumer. An application program for the advertisement information delivery system is installed in the user terminal 4. With the application program, the user terminal 4 can receive and display the advertisement information delivered from the headquarters server 2, order the product in the order system, and send the operation status for the advertisement information to the headquarters server 2.

Next, the headquarters server 2 will be described in detail. FIG. 2 is a block diagram showing a main hardware configuration of the headquarters server 2. The headquarters server 2 includes a control unit 20, a memory unit 21, a display unit 22, an operation unit 23, and a communication unit 24. The control unit 20, the memory unit 21, the display unit 22, the operation unit 23, and the communication unit 24 are connected to each other via a bus 25 or the like.

The control unit 20 includes a computer including a central processing unit (CPU) 201, a read only memory (ROM) 202, and a random access memory (RAM) 203. The CPU 201, the ROM 202, and the RAM 203 are connected to each other via the bus 25.

The CPU 201 controls the overall operation of the headquarters server 2. The ROM 202 stores various programs such as a program used to drive the CPU 201 and various kinds of data. In addition, the RAM 203 is used as a work area of the CPU 201, and loads various programs and various data stored in the ROM 202 and the memory unit 21. The control unit 20 executes various control processes of the headquarters server 2 by operating the CPU 201 in accordance with a control program stored in the ROM 202 or the memory unit 21 and loaded in the RAM 203.

The memory unit 21 includes a storage medium such as a hard disk drive (HDD) or a flash memory, and maintains the stored contents even when the power supply is cut off. The memory unit 21 stores a control program 211, a member master 212, a product master 213, a status master 214, a sales promotion plan master 215, a status management file 216, an order management file 217, a purchase information management file 218, a non-purchase pattern information file 219, and a sales promotion plan setting file 220.

The control program 211 controls the headquarters server 2 to function as an advertisement delivery server that delivers advertisement information to the user terminals 4, an order management server that manages orders from the user terminals 4, and a consumer management server that manages consumer information. The control program 211 may include a program or the like that controls the headquarters server 2 to function as an inventory management server that manages the inventory of each store S.

The member master 212 is a master file that stores information on consumers who are members of the company. FIG. 3 is a diagram showing a data structure of the member master 212. Data registered in the member master 212 is associated with information indicating a member ID, a name, a gender, an address, and an e-mail address. The information registered in the member master 212 is provided by a consumer when registering as a member.

In the item of member ID, a member ID that identifies a consumer is registered. The member ID is one example of the consumer identification information. In the item of name, information indicating the name of the member is registered. In the item of gender, information indicating the gender of the member is registered. In the item of address, information indicating the place of residence of member is registered. In the item of e-mail address, an e-mail address of the user terminal 4 owned by the member is registered.

The product master 213 is a master file that stores product codes and product information in association with each other for the products sold at each store S. Since the products sold at each store S change daily, the product master 213 is updated appropriately. FIG. 4 is a diagram showing a data structure of the product master 213. Data registered in the product master 213 is associated with information indicating a product code, a product name, a price, and an image. The information indicating the product name, the price, and the image are examples of the product information.

In the item of product code, a product code that identifies a product is registered. In the item of product name, information indicating the name of the product is registered. In the item of price, information indicating the unit price of the product is registered. The price may be an amount including the consumption tax or a main unit price not including the consumption tax. In the item of image, data of product images is registered. The product images are photographs and illustrations.

The status master 214 is a master file that defines the operation status of the user terminal 4 (hereinafter, also simply referred to as “operation status”) regarding the advertisement information and the non-purchase pattern of the consumer. The status master 214 can be freely set according to the system configuration or the like of the advertisement information delivery system 1. FIG. 5 is a diagram showing a data structure of the status master 214. Data registered in the status master 214 is associated with information indicating a status ID, an operation status, and a non-purchase pattern. The information indicating the content of the status ID and the operation status is one example of the status information.

In the item of status ID, a status ID that identifies an operation status is registered. In the item of operation status, information indicating the contents of the operation status is registered. The contents of the operation status include “no confirmation of notification”, “no login to order system”, “logged in to order system but no order input”, and “order input”. In the item of non-purchase pattern, information indicating a non-purchase pattern of a consumer is registered corresponding to the operation status of no order input.

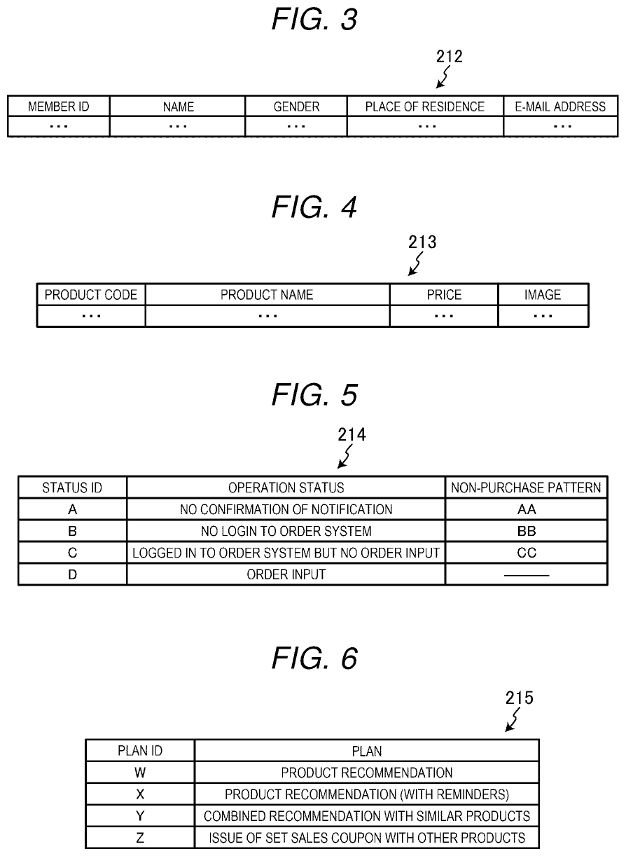

The sales promotion plan master 215 is a master file that defines a set sales promotion plan. The sales promotion plan master 215 can be freely set by a company that uses the advertisement information delivery system 1. FIG. 6 is a diagram showing a data structure of the sales promotion plan master 215. Data registered in the sales promotion plan master 215 is associated with information indicating a plan ID and a plan.

In the item of plan ID, a plan ID that identifies a set sales promotion plan is registered. In the item of plan, information indicating the content of the set sales promotion plan is registered. As one example, the sales promotion plan includes “product recommendation”, “product recommendation (with reminders)”, “combined recommendation with similar products”, and “issue of set sales coupon with other products”.

The “product recommendation” is a method of delivering advertisement information about an advertisement product to the user terminal 4 only once. The “product recommendation (with reminders)” is a method of delivering advertisement information about an advertisement product to the user terminal 4, and re-delivering the advertisement information about the advertisement product to the user terminal 4 of a consumer who did not order the advertisement product after the lapse of a predetermined period. The advertisement information delivered the second time may have the same display content as the advertisement information delivered the first time, or may have different display contents.

The “combined recommendation with similar products” is a method of delivering advertisement information on advertisement products in which an advertisement product in the “product recommendation” and a product similar to the advertisement product are combined. As one example, in a company that sells clothing, when the product to be advertised is a two-piece suit, a three-piece suit that is a similar product can also be used as the advertisement product. As another example, in a company that sells groceries, when the product to be advertised is mandarin oranges, a similar product, navel oranges, can also be used as the advertisement product.

The “issue of set sales coupon with other products” is a method of delivering a set sales coupon for the advertisement product and another product in the “product recommendation”. As one example, in a company that sells clothing, when the advertisement product is a jacket, the advertisement information can include a coupon for discount of purchasing the jacket with trousers as a set. As another example, in a company that sells groceries, when the advertisement product is noodles, the advertisement information can include a coupon for discount of purchasing the noodles with a noodle soup as a set.

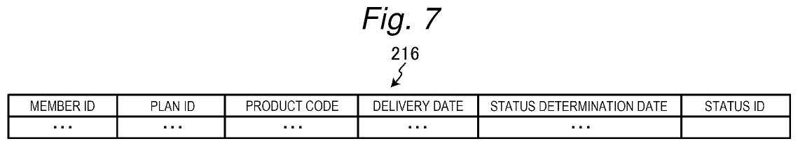

The status management file 216 is a file that manages the operation status of the user terminal 4 regarding the advertisement information delivered by the headquarters server 2 on a consumer basis. The status management file 216 is appropriately updated when the advertisement information is delivered or when the status information is received from the user terminal 4. FIG. 7 is a diagram showing a data structure of the status management file 216. Data registered in the status management file 216 is associated with information indicating a member ID, a plan ID, a product code, a delivery date, a status confirmation date, and a status ID.

In the item of member ID, a member ID that identifies a consumer is registered. In the item of plan ID, a plan ID that identifies a delivered sales promotion plan indicating the method of the delivered advertisement information is registered. In the item of product code, a product ID of an advertisement product notified of by the delivered advertisement information is registered. In the item of delivery date, information indicating a date when advertisement information is delivered to the user terminal 4 is registered.

In the item of status confirmation date item, information indicating a date for confirming an operation status of the user terminal 4 is registered. The date for confirming the operation status is set, for example, two days after the delivery date. In the item of status ID, a status ID that identifies an operation status is registered.

When the advertisement information is delivered by the headquarters server 2, information is registered in the items of the member ID, the plan ID, the product code, the delivery date, and the status confirmation date. Every time the headquarters server 2 receives the status information indicating the operation status of the user terminal 4 for the advertisement information, the status ID is registered or updated.

However, when the operation status indicated by the received status information does not proceed the operation status indicated by the registered status information, the status ID is not updated. In FIG. 5, the “no confirmation of notification” is an operation status in which the operation proceeds the least. The operation status in which the operation proceeds less following “no confirmation of notification” is “no login to order system”. The operation status in which the operation proceeds less following “no login to order system” is “logged in to order system but no order input”, and the operation status in which the operation proceeds the most is “order input”.

The status ID is not updated after the status confirmation date even though an operation is performed on the user terminal 4. For example, under the control of the control unit 20, the update of the status ID is prohibited even though the headquarters server 2 acquires the status information from the user terminal 4 after the status confirmation date. In this case, when the headquarters server 2 receives an order input from the user terminal 4 after the status confirmation date, the headquarters server 2 can receive the order but not update the status management file 216.

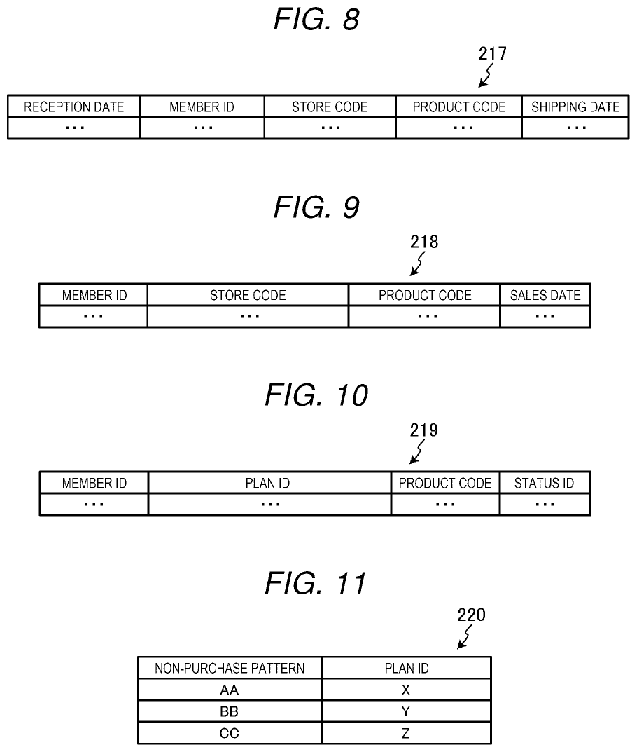

The order management file 217 is a file that manages an order received from the user terminal 4 regarding the products sold at each store S. The order management file 217 registers order data when receiving, from the user terminal 4, status information indicating that an order input was made, and updates the order data when receiving, from the store server 3, information indicating that the product was shipped. FIG. 8 is a diagram showing a data structure of the order management file 217. The order data registered in the order management file 217 is associated with information indicating a reception date, a member ID, a store code, a product code, and a shipping date.

In the item of reception date, information indicating a date when an order is received from the user terminal 4 is registered. In the item of member ID, a member ID that identifies a consumer who ordered a product is registered. In the item of store code, a store code that identifies the store S that provides the product is registered. When the consumer receives the ordered product ordered at the store S, the store code of the store S designated by the consumer is registered. When the consumer receives the ordered product at home, the store code specified by the company is registered according to the location, the inventory status, etc. of each store S.

In the item of product code, a product code that identifies an ordered product is registered. In the item of shipping date, information indicating a date when the ordered product was shipped to the consumer is registered. The information indicating the shipping date is registered based on shipping information received from the store server 3 of the store S identified by the corresponding store code.

The information stored in the order management file 217 is order information indicating whether the consumer ordered the advertisement product notified of by the advertisement information. The information stored in the order management file 217 can be used to identify the product ordered by the consumer and the date on which the order for the product was received, and accordingly whether the consumer ordered the advertisement product within the predetermined period can be specified.

The purchase information management file 218 is a file that manages consumer purchase information in each store S on a trade basis. The purchase information management file 218 is updated based on the purchase information received from the store server 3 of each store S. FIG. 9 is a diagram showing a data structure of the purchase information management file 218. Data registered in the purchase information management file 218 is associated with information indicating a member ID, a store code, a product code, and a sales date.

In the item of member ID, a member ID that identifies a consumer who purchased a product is registered. In the item of store code, a store code that identifies the store S in which a trade was made is registered. In the item of product code, a product code of a traded product is registered. When a plurality of products are purchased in one trade, a plurality of product codes are registered in the item of product code. In the item of sales date, information indicating a date when a trade was made, that is, a date when a consumer purchased a product, is registered.

The non-purchase pattern information file 219 is a file that manages, for each sales promotion plan, the non-purchase patterns of consumers who did not order the advertisement product. In other words, the non-purchase pattern information file 219 can be said to be a file that manages, for each sales promotion plan, the operation status of the consumers who did not order the advertisement product. In a company that does not receive orders from the user terminals 4 and only sells at stores, the non-purchase pattern information file 219 is a file that manages the non-purchase patterns of consumers who did not purchase the advertisement product. FIG. 10 is a diagram showing a data structure of the non-purchased pattern information file 219. Data registered in the non-purchase pattern information file 219 is associated with information indicating a member ID, a plan ID, a product code, and a status ID.

In the item of member ID, a member ID of a consumer who did not order the advertisement product is registered. In the item of plan ID, a plan ID that identifies a delivered sales promotion plan indicating the method of the delivered advertisement information is registered. In the item of product code, a product ID of the advertisement product notified of by the delivered advertisement information is registered. In the item of status ID, a status ID that identifies an operation status is registered.

The information stored in the non-purchase pattern information file 219 is one example of the non-purchase pattern information in which the consumers who are determined as not ordering the advertisement product are associated with the status information on the consumers. In a company that does not receive orders from the user terminals 4 and only sells at stores, in item of member ID, a member ID of the consumer who did not purchase the advertisement product is registered based on the purchase information. Thus, the information stored in the non-purchase pattern information file 219 can be said to be one example of the non-purchase pattern information in which the consumers who are determined as not purchasing the advertisement product are associated with the status information of the consumers.

The sales promotion plan setting file 220 is a file in which a non-purchase pattern of a consumer is associated with a sales promotion plan suitable for the non-purchase pattern. The sales promotion plan setting file 220 stores information determined based on the status information regarding the delivered advertisement information and the order information on the advertisement product. FIG. 11 is a diagram showing a data structure of the sales promotion plan setting file 220. Data registered in the sales promotion plan setting file 220 is associated with information indicating a non-purchase pattern and a plan ID.

In the item of non-purchase patterns, information indicating non-purchase patterns of consumers who did not order the advertisement product is registered. In the item of plan ID, a plan ID that identifies a sales promotion plan that is considered valid for consumers having a corresponding non-purchase pattern is registered. The headquarters server 2 delivers the advertisement information to the user terminal 4 of the consumer having the non-purchase patterns based on the information set in the sales promotion plan setting file 220.

Returning to FIG. 2, the hardware configuration of the headquarters server 2 will be described.

The display unit 22 is implemented by, for example, a liquid crystal panel, and displays various types of information. The display unit 22 displays, for example, the non-purchased pattern information stored in the non-purchased pattern information file 219 as a graph.

The operation unit 23 inputs information to the control unit 20, and includes a keyboard, a touch panel, a mouse, and the like.

The communication unit 24 is an interface for communicating with an external device such as the store server 3 of each store S and the user terminal 4 of each consumer. The control unit 20 can transmit and receive information (data) to and from an external device by being connected to the external device via the communication unit 24.

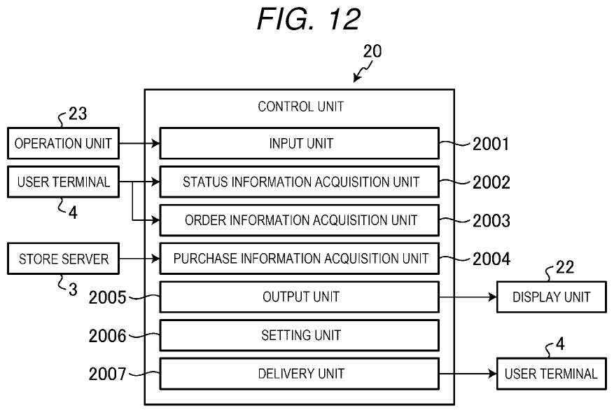

Subsequently, a functional configuration of the control unit 20 of the headquarters server 2 will be described. FIG. 12 is a block diagram showing a main functional configuration of the control unit 20 of the headquarters server 2. With the operation of the CPU 201 according to a control program stored in the ROM 202 or the memory unit 21, the control unit 20 functions as an input unit 2001, a status information acquisition unit 2002, an order information acquisition unit 2003, a purchase information acquisition unit 2004, an output unit 2005, a setting unit 2006, and a delivery unit 2007. These functions may be implemented using hardware such as a dedicated circuit.

Various information is input to the input unit 2001 from the operation unit 23. For example, in the input unit 2001, the information on the product to be notified of by the advertisement information to be delivered, the display format of the advertisement information, and the like are input.

The status information acquisition unit 2002 acquires the status information indicating the operation status of the user terminal 4 regarding the advertisement information delivered to the user terminal 4 of the consumer. The status information acquisition unit 2002 acquires the status information regarding all the deliveries of the advertisement information.

The order information acquisition unit 2003 acquires the order information indicating whether the consumer having the user terminal 4 that is a delivery destination of the advertisement information ordered the advertisement product notified of by the advertisement information. For example, the order information acquisition unit 2003 acquires the order information based on the status information acquired by the status information acquisition unit 2002. More specifically, the order information acquisition unit 2003 acquires the information of the order management file 217 updated by the status information acquired by the status information acquisition unit 2002 from the memory unit 21.

The purchase information acquisition unit 2004 acquires the purchase information indicating whether the consumer having the user terminal 4 that is a delivery destination of the advertisement information purchased the advertisement product notified of by the advertisement information. Specifically, the purchase information acquisition unit 2004 acquires the purchase information from the store server 3 of each store S.

The output unit 2005 outputs the non-purchase pattern information in which the consumers who are determined as not ordering the advertisement product based on the order information acquired by the order information acquisition unit 2003 is associated with the status information on the consumers acquired by the status information acquisition unit 2002. The output unit 2005 also outputs the non-purchase pattern information in which the consumers who are determined as not purchasing the advertisement product based on the order information acquired by the purchase information acquisition unit 2004 is associated with the status information on the consumers acquired by the status information acquisition unit 2002. The output unit 2005 outputs various other information to the display unit 22 or an external device as needed.

The setting unit 2006 sets a sales promotion plan that defines the method of advertisement information for each piece of status information included in the non-purchase pattern information output by the output unit 2005. For example, the setting unit 2006 sets a sales promotion plan for each piece of non-purchaser status information, in other words, a sales promotion plan for each non-purchase pattern, determined by the company based on the non-purchase pattern information output by the output unit 2005. In this case, the setting unit 2006 registers the plan ID in the sales promotion plan setting file 220 based on the information input from the operation unit 23 to the input unit 2001. The setting unit 2006 may register, in the sales promotion plan setting file 220, the plan ID of the sales promotion plan determined by the process of the control unit 20.

The delivery unit 2007 delivers the advertisement information to the consumer user terminal 4 based on the sales promotion plan set by the setting unit 2006. In the present embodiment, the delivery unit 2007 delivers the advertisement information according to the contents of the sales promotion plan setting file 220 shown in FIG. 11.

For example, in the example shown in FIG. 11, the delivery unit 2007 delivers the advertisement information according to the sales promotion plan X to the consumers having the non-purchase pattern AA (without confirmation of the notification of the advertisement information) in the delivery for measurement. The delivery unit 2007 delivers the advertisement information according to the sales promotion plan Y to the consumers having the non-purchase pattern BB (no login to the order system) in the delivery for measurement. Furthermore, the delivery unit 2007 delivers the advertisement information according to the sales promotion plan Z to the consumers having the non-purchase pattern CC (logged in to the order system but no order input) in the delivery for measurement.

The above sales promotion plans are merely examples and can be set freely. The delivery unit 2007 also performs the delivery for data collection and the delivery for measurement. The delivery for data collection is performed by delivering the advertisement information to the user terminals 4 of all the members by a sales promotion plan W regardless of the contents stored in the sales promotion plan setting file 220.

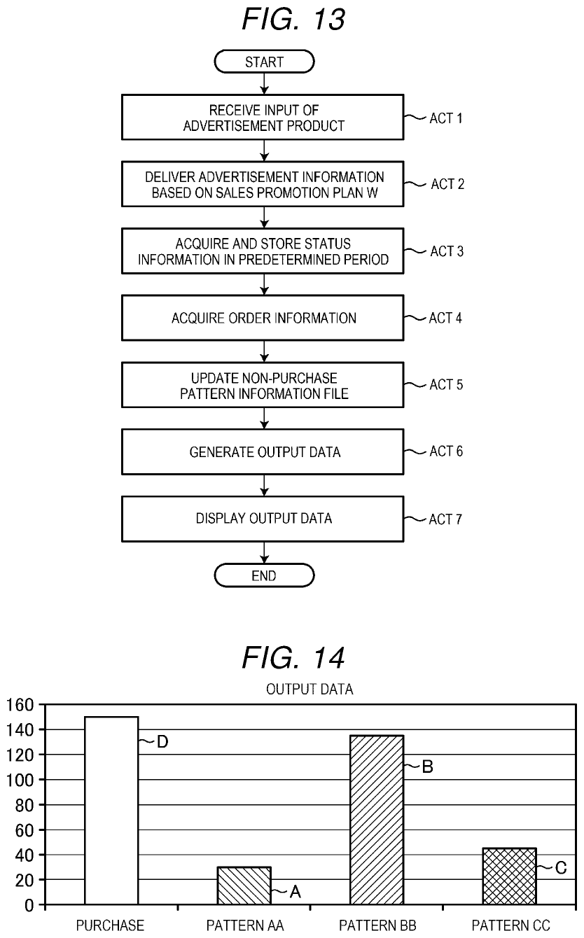

Next, the non-purchase pattern information output process executed by the headquarters server 2 having the above configuration in the first act will be described. The non-purchase pattern information output process provides non-purchase patterns of consumers regarding advertisement information to a company that sells a product. FIG. 13 is a flowchart showing a flow of the non-purchase pattern information output process by the control unit 20.

First, the input unit 2001 receives an input of information related to an advertisement product (ACT 1). Thereafter, the delivery unit 2007 delivers the advertisement information to all the consumers registered as members based on the sales promotion plan W (ACT 2). That is, the delivery unit 2007 performs the delivery for data collection. In this case, the control unit 20 registers information in each item of the status management file 216.

After that, the status information acquisition unit 2002 acquires the status information in a predetermined period and appropriately updates the item of status ID of the status management file 216 (ACT 3). Thereafter, the order information acquisition unit 2003 acquires the order information (ACT 4). The order information acquisition unit 2003 acquires the order information by acquiring the information of the status management file 216. When the company sells products only in stores, the purchase information acquisition unit 2004 acquires the purchase information from the store server 3 of each store S in ACT 4.

The control unit 20 updates the non-purchase pattern information file 219 based on the status information acquired by the status information acquisition unit 2002 and the order information acquired by the order information acquisition unit 2003 (ACT 5).

The output unit 2005 generates output data based on the updated non-purchase pattern information file 219 (ACT 6), and outputs the output data to the display unit 22 (ACT 7). The control unit 20 then ends the non-purchase pattern information output process.

FIG. 14 is a diagram showing one example of the output data displayed on the display unit 22. The output data is a graph showing the items of the operation status of the consumers to whom the advertisement information was delivered. The number in “purchase” is the number of consumers who purchased the advertisement product, in other words, the number of consumers whose status ID is registered as D in the non-purchase pattern information file 219.

The number in the pattern AA is the number of people whose non-purchase pattern is AA, in other words, the number of consumers whose status ID is registered as A in the non-purchase pattern information file 219. The number in the pattern BB is the number of people whose non-purchase pattern is BB, in other words, the number of consumers whose status ID is registered as B in the non-purchase pattern information file 219. The number in the pattern CC is the number of people whose non-purchase pattern is CC, in other words, the number of consumers whose status ID is registered as C in the non-purchase pattern information file 219.

In this way, the headquarters server 2 can provide, to the company selling the product, a result of the analyzing the consumers who did not order (or did not purchase) the advertisement product. Specifically, non-purchase patterns according to the operation status of the user terminals 4 and information on consumers belonging to each non-purchase pattern can be provided. Companies can use the results of analysis from a new perspective of operation status regarding advertisement information to consider how to make the advertisement information to be delivered more effective.

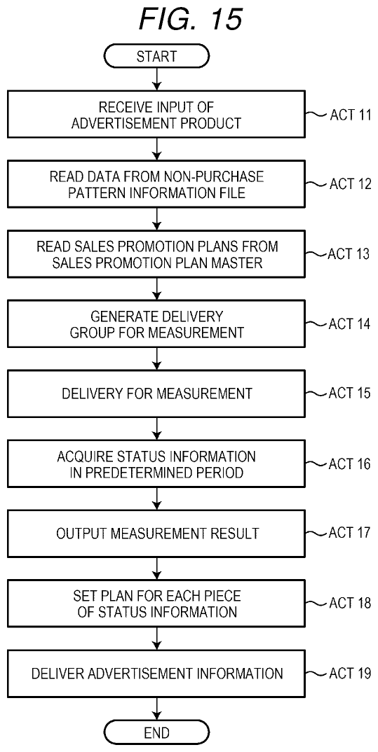

Next, the sales promotion plan setting process executed by the headquarters server 2 in the second act and the third act will be described. The sales promotion plan setting process sets a sales promotion plan determined based on a result of the delivery for measurement and delivers advertisement information according to the set sales promotion plan. FIG. 15 is a flowchart showing a flow of the sales promotion plan setting process by the control unit 20.

First, the input unit 2001 receives the input of the information related to the advertisement product notified of by the delivery for measurement (ACT 11). The advertisement product notified of by the delivery for measurement is desirably the same as the product notified of by the delivery for data collection. Thereafter, the setting unit 2006 reads data from the non-purchase pattern information file 219 and classifies consumers by the status ID (ACT 12). The setting unit 2006 reads the sales promotion plans from the sales promotion plan master 215 (ACT 13) and generates a delivery group for measurement (ACT 14).

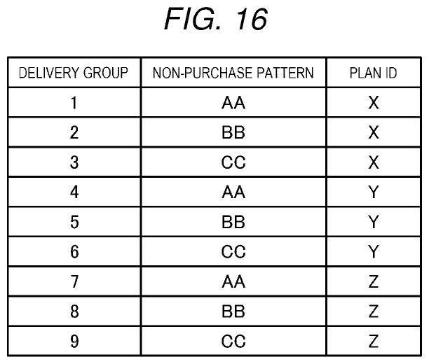

FIG. 16 is a diagram showing the generated delivery group for measurement. The delivery group for measurement classifies non-purchasers in the delivery for data collection into nine groups based on a combination of three non-purchase patterns and three sales promotion plans.

More specifically, the delivery group for measurement is generated as follows. The number of consumers whose non-purchase pattern is AA, in other words, consumers whose status ID was A in the delivery for data collection is divided into three equal groups, and the three groups are associated with the sales promotion plans X, Y, and Z. The number of consumers whose non-purchase pattern is BB, in other words, consumers whose status ID was B in the delivery for data collection is divided into three equal groups, and the three groups are associated with the sales promotion plans X, Y, and Z. Furthermore, the number of consumers whose non-purchase pattern is CC, in other words, consumers whose status ID was C in the delivery for data collection is divided into three equal groups, and the three groups are associated with the sales promotion plans X, Y, and Z. As a result, the delivery group for measurement classified into nine groups is generated.

Thereafter, the delivery unit 2007 delivers the advertisement information according to the generated delivery group for measurement (ACT 15). That is, the delivery unit 2007 performs the delivery for measurement. Subsequently, the status information acquisition unit 2002 acquires the status information in a predetermined period from each user terminal 4 that is the delivery destination of the advertisement information (ACT 16). The setting unit 2006 outputs a measurement result based on the acquired status information (ACT 17).

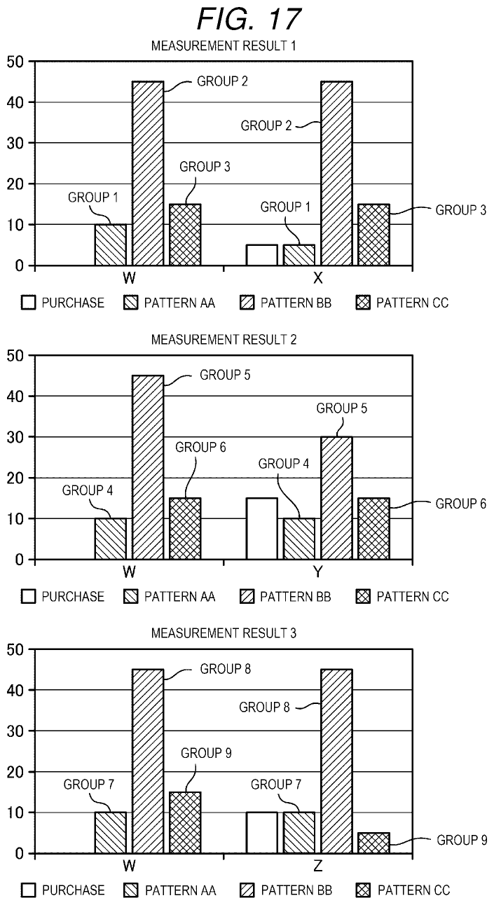

FIG. 17 is a graph showing examples of the measurement result, in which the horizontal axis shows a sales promotion plan and the vertical axis shows the number of consumers. The graph of a measurement result 1 shows how the non-purchase patterns of the consumers change as a result of the delivery for measurement by the sales promotion plan X for consumers belonging to groups 1, 2 and 3 who are non-purchasers in the delivery for data collection by the sales promotion plan W.

In this example, as a result of changing the sales promotion plan W to the sales promotion plan X, no change occurs in the non-purchase patterns of the consumers in the group 2 or the group 3, while a part of the consumers in group 1 purchased the advertisement product. Thus, the sales promotion plan X can be understood as effective for the consumers having the non-purchase pattern AA.

The graph of a measurement result 2 shows how the non-purchase patterns of the consumers change as a result of the delivery for measurement by the sales promotion plan Y for consumers belonging to groups 4, 5 and 6 who are non-purchasers in the delivery for data collection by the sales promotion plan W.

In this example, as a result of changing the sales promotion plan W to the sales promotion plan Y, no change occurs in the non-purchase patterns of the consumers in the group 4 or the group 6, while a part of the consumers in group 5 purchased the advertisement product. Thus, the sales promotion plan Y can be understood as effective for the consumers having the non-purchase pattern BB.

The graph of a measurement result 3 shows how the non-purchase patterns of the consumers change as a result of the delivery for measurement by the sales promotion plan Z for consumers belonging to groups 7, 8 and 9 who are non-purchasers in the delivery for data collection by the sales promotion plan W.

In this example, as a result of changing the sales promotion plan W to the sales promotion plan W, no change occurs in the non-purchase patterns of the consumers in the group 7 or the group 8, while a part of the consumers in group 9 purchased the advertisement product. Thus, the sales promotion plan Z can be understood as effective for the consumers having the non-purchase pattern CC. The measurement result output form shown in FIG. 17 is one example and can be set freely.

For example, a person in charge of the company who recognized the expected result output shown in FIG. 17 determines a sales promotion plan that seems to be effective for each non-purchase pattern in the delivery for data collection, and inputs the information by the operations of the operation unit 23. In the above example, information is input in which the sales promotion plan X is associated with the consumers whose non-purchase pattern was AA, the sales promotion plan Y is associated with the consumers whose non-purchase pattern was BB, and the sales promotion plan Z is associated with the consumers whose non-purchase pattern was CC.

The setting unit 2006 sets a plan for each piece of status information by registering the input information in the sales promotion plan setting file 220 (ACT 18). The control unit 20 may automatically set the plan for each status information. In this case, ACT 17 can be omitted. Thereafter, the delivery unit 2007 delivers the subsequent advertisement information based on the set sales promotion plan (ACT 19).

By the above sales promotion plan setting process, an effective sales promotion plan according to the non-purchase pattern can be set.

Next, a modification will be described. The modification relates to delivering advertisement information by narrowing the delivery target down to consumers who are considered to be interested in the advertisement product. Whether to narrow down the number of consumers can be decided for each delivery of the advertisement information.

In the modification, a product characteristic information file 221 and a consumer characteristic information file 222 are further stored in the memory unit 21 of the headquarters server 2.

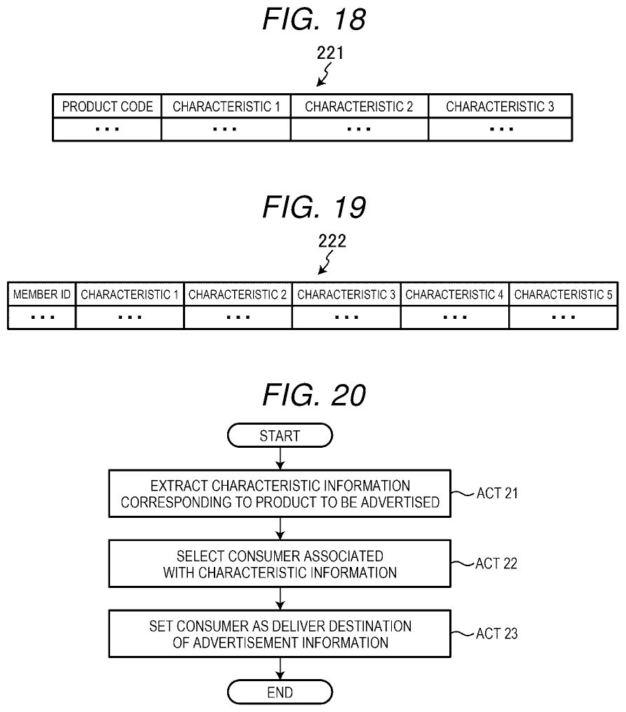

The product characteristic information file 221 stores characteristic information predetermined by the company for each product, and stores a product code, which is product identification information, in association with the characteristic information indicating characteristics of the product. FIG. 18 is a diagram showing a data structure of the product characteristic information file 221. Data registered in the product characteristic information file 221 is associated with information indicating the product code, a characteristic 1, a characteristic 2, and a characteristic 3. The characteristic information predetermined according to the product code is not limited to three, and can be freely set. The number of corresponding characteristic information may be changed for each product.

In the item of product code, a product code that identifies a product is registered. In the items of characteristic 1, characteristic 2, and characteristic 3, the characteristic information indicating the characteristics of the product is registered. When the product code indicates “organic vegetable packed meal”, for example, the following information is registered in the items of characteristic 1, characteristic 2, and characteristic 3.

Since the product is a kind of packed meal, information indicating “packed meal” is registered in the item of characteristic 1. Since the product is mainly vegetables, information indicating “vegetables” is registered in the item of characteristic 2. Since the product is often purchased during the meal hour, information indicating “meal hour” is registered in the item of characteristic 3.

The consumer characteristic information file 222 stores characteristic information for each consumer, and stores the member ID, which is the consumer identification information, in association with the characteristic information. The consumer characteristic information file 222 is generated and updated based on the purchase information acquired from the store server 3 of each store S. FIG. 19 is a diagram showing a data structure of the consumer characteristic information file 222. Data registered in the consumer characteristic information file 222 is associated with information indicating the member ID, characteristic 1, characteristic 2, characteristic 3, characteristic 4, and characteristic 5. The characteristic information set corresponding to the member ID is not limited to five, and can be set to any number. The number of corresponding characteristic information may be changed for each consumer.

In the item of member ID, a member ID that identifies a consumer is registered. In the items of characteristic 1 to characteristic 5, characteristic information indicating characteristics of the consumer is registered. The characteristic information registered in the items of the characteristic 1 to the characteristic 5 is the characteristic information classified in the same manner as the characteristic information registered in the product characteristic information file 221. Accordingly, products can be matched with consumers by the characteristic information.

The information registered in the items of the characteristic 1 to the characteristic 5 is the specific information selected as a result of analyzing the purchase information acquired from the store server 3 of each store S. For example, the control unit 20 extracts all the characteristic information corresponding to all the products purchased by a consumer identified by a member ID in a predetermined period, and registers the top five pieces of characteristic information having the largest number of extractions in the items of characteristic 1 to characteristic 5 of the consumer characteristic information file 222. Thus, for example, “vegetable” is registered in the item of characteristic 1, “beer” is registered in the item of characteristic 2, “packed meal” is registered in the item of characteristic 3, “frozen food” is registered in the item of characteristic 4, and “meal hour” is registered in the item of characteristic 5. The method of analyzing the purchase information is not limited to the above and can be any method. The characteristic information selected based on the purchase information is updated regularly (for example, once a month).

Next, a delivery target narrowing process executed by the headquarters server 2 having the product characteristic information file 221 and the consumer characteristic information file 222 will be described. FIG. 20 is a flowchart showing the flow of the delivery target narrowing process by the control unit 20. The delivery target narrowing process is executed, for example, after the information related to the advertisement product is input in the delivery of the advertisement information, that is, after the advertisement product is determined.

The control unit 20 extracts the characteristic information corresponding to the determined advertisement product from the product characteristic information file 221 (ACT 21). Subsequently, the control unit 20 selects a consumer associated with the characteristic information extracted in ACT 21 in the consumer characteristic information file 222 (ACT 22). That is, the control unit 20 matches the product and the consumer by the characteristic information, and selects the consumer that matches the advertisement product.

Thereafter, the control unit 20 sets the selected consumer as a delivery destination of the advertisement information (ACT 23). The delivery unit 2007 delivers the advertisement information to the user terminal 4 of the consumer set as delivery destination.

Accordingly, the headquarters server 2 can deliver the advertisement information by narrowing the delivery target down to the consumers who are considered to match the advertisement product, in other words, the consumers who are considered to have a high possibility of purchasing the advertisement product. Thus, the headquarters server 2 can reduce the useless deliveries of advertisement information, and can reduce the load of managing the status information. For consumers, the discomfort feeling by being provided with unnecessary advertisement information is reduced.

As described above, the headquarters server 2 of the embodiment includes the status information acquisition unit 2002 configured to acquire status information indicating an operation status of the user terminal 4 of a consumer regarding advertisement information delivered to the user terminal 4, an order information acquisition unit 2003 configured to acquire order information indicating whether the consumer having the user terminal 4 that is a delivery destination of the advertisement information ordered an advertisement product notified of by the advertisement information, and the output unit 2005 configured to output non-purchase pattern information in which a consumer who is determined as not ordering the advertisement product based on the order information acquired by the order information acquisition unit 2003 is associated with the status information on the consumer acquired by the status information acquisition unit 2002.

Accordingly, for the consumer who did not order the advertisement product, the headquarters server 2 can provide, to the company or the like that sells products, information in which a non-purchase pattern corresponding to an operation status of the user terminal 4 is associated with the consumer. The company provided with the information can consider effective advertisement information from a new perspective that was not seen before.

Furthermore, the order information acquisition unit 2003 of the headquarters server 2 of the embodiment acquires the order information based on the status information acquired by the status information acquisition unit 2002.

Accordingly, the status information acquisition unit 2002 that recognizes the operation status of the user terminal 4 can be used for acquiring the order information. Thus, the order information is not necessarily acquired separately from the store S.

The headquarters server 2 of the embodiment includes the status information acquisition unit 2002 configured to acquire status information indicating an operation status of the user terminal 4 of a consumer regarding advertisement information delivered to the user terminal 4, a purchase information acquisition unit 2004 configured to acquire purchase information indicating whether the consumer having the user terminal 4 that is a delivery destination of the advertisement information purchased an advertisement product notified of by the advertisement information, and an output unit 2005 configured to output non-purchase pattern information in which a consumer who is determined as not purchasing the advertisement product based on the purchase information acquired by the purchase information acquisition unit 2004 is associated with the status information on the consumer acquired by the status information acquisition unit 2002.

Accordingly, for the consumer who did not purchase the advertisement product, the headquarters server 2 can provide, to the company or the like that sells products, information in which a non-purchase pattern corresponding to an operation status of the user terminal 4 is associated with the consumer. The company provided with the information can consider effective advertisement information from a new perspective that was not seen before.

In addition, the headquarters server 2 of the embodiment further includes the setting unit 2006 configured to set a sales promotion plan that defines a method of the advertisement information for each piece of the status information included in the non-purchase pattern information output by the output unit 2005.

Thus, the headquarters server 2 can set a sales promotion plan suitable for each non-purchase pattern.

Further, the headquarters server 2 of the embodiment further includes the delivery unit 2007 configured to deliver the advertisement information to the user terminal 4 of the consumer based on the sales promotion plan set by the setting unit 2006.

Thus, the headquarters server 2 can deliver the advertisement information with an effective sales promotion plan according to the non-purchase pattern of the consumer.

According to the above embodiment, the control program executed by the headquarters server 2, the store server 3, and the user terminal 4, which are information processing devices, may be recorded and provided on a computer-readable recording medium such as a CD-ROM. The control program executed by the headquarters server 2, the store server 3, and the user terminal 4 of the above embodiment may be stored in a computer connected to a network such as the Internet and provided by being downloaded via the network, or may be provided via the network such as the Internet.

While the embodiment described herein is explained above, the embodiment is presented by way of example only, and is not intended to limit the scope of the disclosure. The embodiment described herein may be implemented in a variety of other forms, and various omissions, substitutions and changes may be made without departing from the spirit of the disclosure.

What is claimed is:

1. An information processing device, comprising:
a status information acquisition component configured to acquire status information indicating an operation status of a user terminal of a consumer regarding advertisement information delivered to the user terminal;
an order information acquisition component configured to acquire order information indicating whether the consumer having the user terminal that is a delivery destination of the advertisement information ordered an advertisement product notified of by the advertisement information; and
an output component configured to output non-purchase pattern information in which a consumer who is determined as not ordering the advertisement product based on the order information acquired by the order information acquisition component is associated with the status information on the consumer acquired by the status information acquisition component.

2. The information processing device according to claim 1, wherein the order information acquisition component acquires the order information based on the status information acquired by the status information acquisition component.

3. The information processing device according to claim 1, further comprising:
a setting component configured to set a sales promotion plan that defines a method of the advertisement information for each piece of the status information in the non-purchase pattern information output by the output component.

4. The information processing device according to claim 3, further comprising:
a delivery component configured to deliver the advertisement information to the user terminal of the consumer based on the sales promotion plan set by the setting component.

5. The information processing device according to claim 3, wherein the method of the advertisement information comprises at least one of a product recommendation, a product recommendation and a reminder, a combined recommendation with similar products, and an issue of sales coupon with other products.

6. An information processing device, comprising:
a status information acquisition component configured to acquire status information indicating an operation status of a user terminal of a consumer regarding advertisement information delivered to the user terminal;
a purchase information acquisition component configured to acquire purchase information indicating whether the consumer having the user terminal that is a delivery destination of the advertisement information purchased an advertisement product notified of by the advertisement information; and
an output component configured to output non-purchase pattern information in which a consumer who is determined as not purchasing the advertisement product based on the purchase information acquired by the purchase information acquisition component is associated with the status information on the consumer acquired by the status information acquisition component.

7. The information processing device according to claim 6, further comprising:
a setting component configured to set a sales promotion plan that defines a method of the advertisement information for each piece of the status information in the non-purchase pattern information output by the output component.

8. The information processing device according to claim 7, further comprising:
a delivery component configured to deliver the advertisement information to the user terminal of the consumer based on the sales promotion plan set by the setting component.

9. The information processing device according to claim 7, wherein the method of the advertisement information comprises at least one of a product recommendation, a product recommendation and a reminder, a combined recommendation with similar products, and an issue of sales coupon with other products.

10. A method for controlling an information processing device with a computer, the method causing the computer to perform functions including:
acquiring status information indicating an operation status of a user terminal of a consumer regarding advertisement information delivered to the user terminal;
acquiring order information indicating whether the consumer having the user terminal that is a delivery destination of the advertisement information ordered an advertisement product notified of by the advertisement information; and
outputting non-purchase pattern information in which a consumer who is determined as not purchasing the advertisement product based on the order information acquired is associated with the status information on the consumer acquired.

11. The method according to claim 10, further comprising:
acquiring the order information based on the status information acquired.

12. The method according to claim 10, further comprising:
setting a sales promotion plan that defines a method of the advertisement information for each piece of the status information in the non-purchase pattern information output.

13. The method according to claim 12, further comprising:
delivering the advertisement information to the user terminal of the consumer based on the sales promotion plan set.

14. The method according to claim 12, wherein the method of the advertisement information comprises at least one of a product recommendation, a product recommendation and a reminder, a combined recommendation with similar products, and an issue of sales coupon with other products.

15. A method for controlling an information processing device with a computer, the method causing the computer to perform functions including:
acquiring status information indicating an operation status of a user terminal of a consumer regarding advertisement information delivered to the user terminal;
acquiring purchase information indicating whether the consumer having the user terminal that is a delivery destination of the advertisement information purchased an advertisement product notified of by the advertisement information; and
outputting non-purchase pattern information in which a consumer who is determined as not purchasing the advertisement product based on the purchase information acquired is associated with the status information on the consumer acquired.

16. The method according to claim 15, further comprising:
setting a sales promotion plan that defines a method of the advertisement information for each piece of the status information in the non-purchase pattern information output.

17. The method according to claim 16, further comprising:
delivering the advertisement information to the user terminal of the consumer based on the sales promotion plan set.

18. The method according to claim 16, wherein the method of the advertisement information comprises at least one of a product recommendation, a product recommendation and a reminder, a combined recommendation with similar products, and an issue of sales coupon with other products.
